(19) United States
(12) Patent Application Publication
(10) Pub. No.: US 2023/0069033 A1
(43) Pub. Date: Mar. 2, 2023

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Satoshi KONDO, Kanagawa (JP)

(73) Assignee: FUJIFILM Business Innovation Corp., Tokyo (JP)

(21) Appl. No.: 17/646,894

(22) Filed: Jan. 4, 2022

(30) Foreign Application Priority Data
Aug. 31, 2021 (JP) 2021-141642

(51) Int. Cl. H04N 1/44

(52) U.S. Cl. CPC H04N 1/4493

(57) ABSTRACT

An information processing apparatus includes a processor configured to: receive a request to view a document, from a viewing user who views the document; obtain a document file having document information and specification information, the document information describing content of the document, the specification information including multiple figures disposed on the document, the figures having multiple format types, the figures being used to specify areas in the document; obtain user information describing the viewing user; and, in display of the document to the viewing user, determine hidden areas on the basis of a format type associated with the user information in advance, the hidden areas being in the document and being areas in which the content of the document is not displayed.

### CROSS-REFERENCE TO RELATED APPLICATIONS

This application is based on and claims priority under 35 USC 119 from Japanese Patent Application No. 2021-141642 filed Aug. 31, 2021.

### BACKGROUND

### (i) Technical Field

The present disclosure relates to an information processing apparatus, a non-transitory computer readable medium, and an information processing method.

### (ii) Related Art

In a system which makes users view documents which are electronically stored, confidential information in the documents may be different depending on each user. Therefore, various techniques for making users view documents by hiding different confidential information in accordance with each user have been disclosed.

Japanese Unexamined Patent Application Publication No. 2004-94542 describes a document management system in which parts of a document that is open to the outside are partially subjected to a concealing process and are partially hidden in an electronic document-management environment. The document management system includes a document-structure generating function, having a document-logic-structure edit mechanism and a document-structure output mechanism, and a public-document generating function, having an automatic masking mechanism and a manual masking mechanism. A created document or a Portable Document Format (PDF) document of the created document and an eXtensible Markup Language (XML) document indicating the document logic structure are used as an original document. The document-logic-structure edit mechanism performs position specification on an original document and stores its document logic structure. The document-structure output mechanism analyzes the document logic structure and adds XML tags in accordance with the analysis result. The automatic masking mechanism reads the original, reads the XML, and performs a concealing process. The manual masking mechanism reads the PDF, additionally edits a logic structure, and performs a concealing process. The document management system generates, for output, either or both of a partially-concealed PDF document and a concealing XML document which are documents open to the outside.

Japanese Unexamined Patent Application Publication No. 2011-227536 describes a masking system of masking characters included in an electronic document. The masking system includes a storage unit, an acquisition unit, a conversion unit, and an update unit. The storage unit stores, in advance, a list defining the project code that indicates a project, the string that is a conversion target, the converted string that is a string obtained after conversion of a string that is a conversion target, the value corresponding to specified scope of disclosure, and the specific conversion reason. The acquisition unit receives a request for authentication and acquires, from the authenticated user ID, the name of the user, the department of the user, and the project code of a project to which the user belongs. The conversion unit converts a string, which is in an electronic document specified as a conversion process target, into a different string by using a project code, a value corresponding to the specified scope of disclosure, and a string conversion table defined for each specific conversion reason. The update unit adds, in the string conversion table, a conversion process originated from a project, and updates the string conversion table.

When a document is to be provided to the outside, the document (so-called masked document) may be delivered by filling its areas such as confidential matters restricted on viewing.

In delivery of a document to multiple users, masked areas may be changed depending on each user, and the resulting document may be delivered. In this case, it is necessary to specify masked areas on multiple documents generated for the respective users or user groups, or to generate a masked image dynamically by embedding tag information or the like in a document in advance and using a user dictionary to manage the access level.

### SUMMARY

Aspects of non-limiting embodiments of the present disclosure relate to a system which enables easy setting of the scope of disclosure of a document file which needs partial restriction on viewing the document file depending on each viewing user, compared with a system which sets the scope of disclosure to multiple documents generated for the respective users.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: receive a request to view a document, from a viewing user who views the document; obtain a document file having document information and specification information, the document information describing content of the document, the specification information including a plurality of figures disposed on the document, the plurality of figures having a plurality of format types, the plurality of figures being used to specify areas in the document; obtain user information describing the viewing user; and, in display of the document to the viewing user, determine hidden areas on a basis of a format type associated with the user information in advance, the hidden areas being in the document and being areas in which the content of the document is not displayed.

### BRIEF DESCRIPTION OF THE DRAWINGS

Exemplary embodiments of the present disclosure will be described in detail based on the following figures, wherein:

FIG. 1 is a diagram illustrating an exemplary overall configuration of a document management system according to the present exemplary embodiment;

FIG. 2 is a diagram illustrating an exemplary hardware configuration of a server according to the present exemplary embodiment;

FIG. 3 is a diagram illustrating an exemplary hardware configuration of a user terminal according to the present exemplary embodiment;

FIG. 4 is a diagram illustrating the state in which a manager specifies areas on a paper document by using marker pens;

FIGS. 5A to 5C are diagrams illustrating document images displayed depending on the user categories of viewing users when the users view the document in FIG. 4;

FIG. 6 is a diagram illustrating an exemplary functional configuration of a server according to the present exemplary embodiment;

FIG. 7 is a diagram for describing document files stored in a database;

FIG. 8 is an exemplary table in which the user category is associated with the format type;

FIG. 9 is a flowchart of a process performed by a server in user authentication;

FIG. 10A is a flowchart of a process performed by a server in registration of a document;

FIG. 10B is a flowchart of a process performed by a server in registration of a document;

FIG. 11 is a flowchart of a process performed by a server in displaying a document to a user; and

FIG. 12 is a flowchart of a process performed by a server in reception of area specification using an electronic pen.

### DETAILED DESCRIPTION

Referring to the attached drawings, exemplary embodiments of the present disclosure will be described in detail below.

### The Overall Configuration of a Document Management System

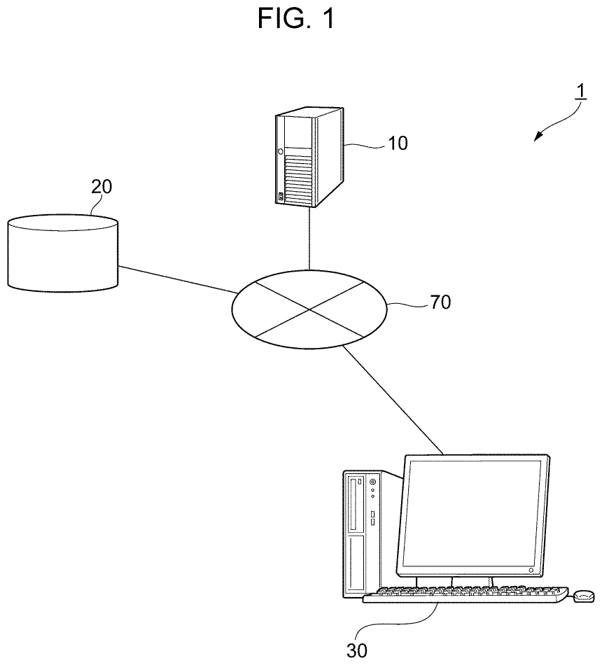

FIG. 1 is a diagram illustrating an exemplary overall configuration of a document management system 1 according to the present exemplary embodiment.

The document management system 1 according to the present exemplary embodiment includes a server 10 that controls the entire system, a database 20 that stores documents managed by the server 10, and a user terminal 30 that is a terminal used by a user. The database 20 and the user terminal 30 are connected to the server 10 over a network 70.

### The Hardware Configuration of the Server

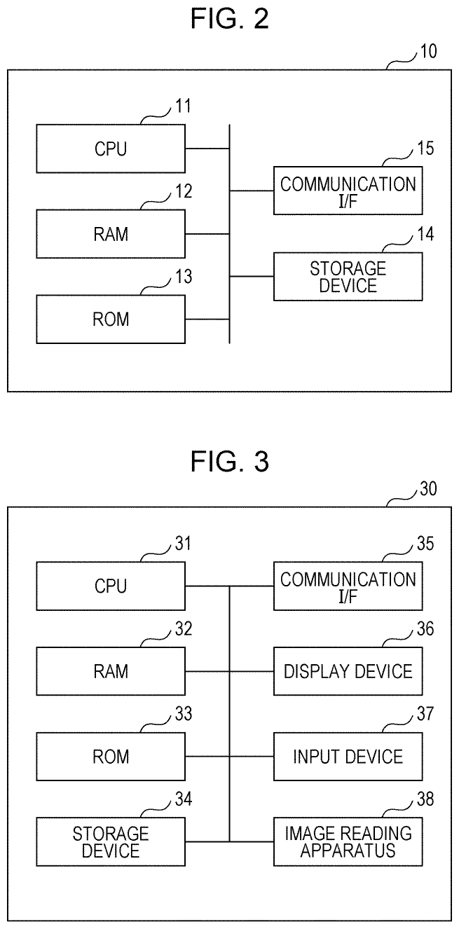

Referring to FIG. 2, the hardware configuration of the server 10 according to the present exemplary embodiment will be described.

FIG. 2 is a diagram illustrating an exemplary hardware configuration of the server 10 according to the present exemplary embodiment.

The server 10 includes a central processing unit (CPU) 11 which is a computation unit, a random access memory (RAM) 12 which is a storage unit, a read only memory (ROM) 13, a storage device 14, and a communication interface (communication I/F) 15 for communicating with the outside. The RAM 12, which is a main storage device (main memory), is used as a work area when the CPU 11 performs computations. The ROM 13 holds programs and data such as setting values prepared in advance. The CPU 11 reads programs and data directly from the ROM 13 to perform processing. The storage device 14 is a unit storing programs and data. The storage device 14 stores programs. The CPU 11 reads programs, which are stored in the storage device 14, to the main storage device for execution. The storage device 14 stores results of processing performed by the CPU 11. Examples of the storage device 14 include a magnetic disk device and a solid state drive (SSD).

### The Hardware Configuration of the User Terminal 30

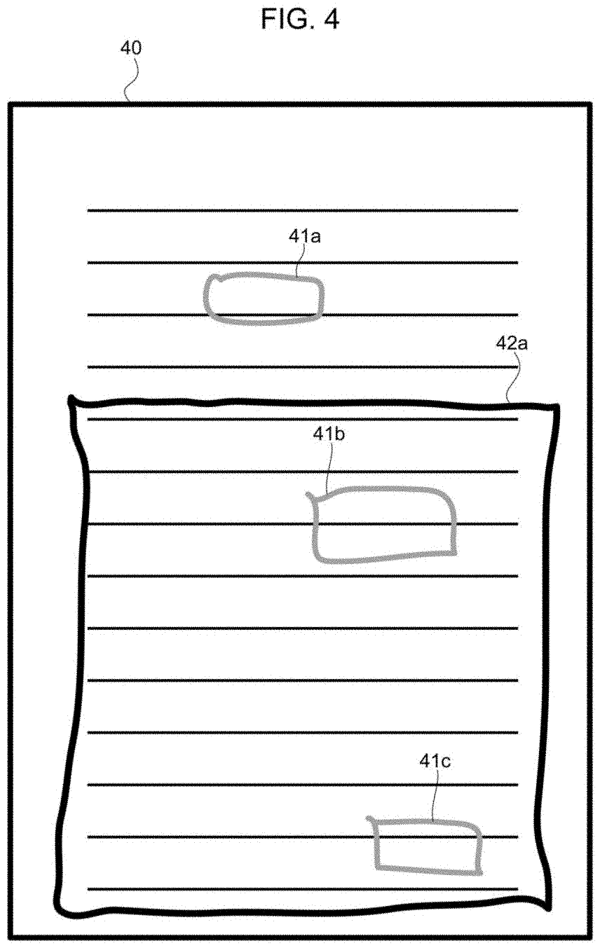

FIG. 3 is a diagram illustrating an exemplary hardware configuration of the user terminal 30 according to the present exemplary embodiment.

The user terminal 30 includes a CPU 31 which is a computation unit, a RAM 32 which is a storage unit, a ROM 33, a storage device 34, a communication I/F 35 for communicating with the outside, a display device 36 for presenting information to a user, and an input device 37 for a user performing an input operation on the user terminal. The user terminal 30 includes an image reading apparatus 38, which reads document images, when necessary. The RAM 32, which is a main storage device (main memory), is used as a work memory when the CPU 31 performs computations. The ROM 33 holds programs and data such as setting values prepared in advance. The CPU 31 reads programs and data directly from the ROM 33 to perform processing. The storage device 34 is a unit storing programs and data. The storage device 34 stores programs. The CPU 31 reads programs, which are stored in the storage device 34, to the main storage device for execution. The storage device 34 stores results of processing performed by the CPU 31. Examples of the storage device 34 include a magnetic disk device and an SSD.

The display device 36 has functions for displaying images to a user, and is, for example, a liquid-crystal display or an organic light emitting display. Examples of the input device 37 include a keyboard, a mouse, and a touch panel. The image reading apparatus 38, which is, for example, a scanner, optically reads an image of a document which is set, and generates a read image (image data).

The user terminal 30 is, for example, an information terminal, such as a personal computer (PC), a notebook computer, a tablet terminal, or a smartphone.

### The Overview of the Document Management System

The document management system 1 according to the present exemplary embodiment receives a request to view a document, from a viewing user who wants to view the document, and displays the document with a partial restriction on viewing the document, depending on the category of the viewing user. More specifically, the document management system 1 allows documents, which are handled by A Corp., to be viewed by persons who belong to A Corp. (hereinafter referred to “internal users”) and persons who do not belong to A Corp. (hereinafter referred to as “external users”). The document management system 1 is capable of making each document have hidden areas different depending on whether a viewing user is an internal user or an external user.

The “category of a viewing user” is a category predetermined for the viewing user, and is exemplary information about the viewing user. In the document management system 1 according to the present exemplary embodiment, a viewing user is categorized, in advance, into any of three categories, “manager”, “internal user”, and “external user”. The “manager” indicates a person who manages the document management system 1, for example, a person in charge of management of confidential information in A Corp. An example in which a manager specifies areas restricted on document viewing will be described below. However, a person, who specifies areas restricted on document viewing, is not limited to a manager who manages the document management system 1.

For each document, the document management system 1 receives, from a manager, specification of areas restricted on viewing of the document. Specification of areas restricted on document viewing is made for each user category.

Before storage of a paper document in the database 20, a manager physically specifies, by using marker pens, hidden areas restricted on document viewing, and uploads the document to a cloud. The manager draws multiple substantially rectangular figures on a paper document by using multiple markers of predetermined colors. The predetermined colors are such colors that a different color is defined for each user category. The color type indicates an exemplary format. The manager scans a document on which figures are drawn by using markers, and transmits, to the server 10, the scanned image obtained through scanning. The server 10, which receives the image, discriminates the figures, which are drawn by using markers, from the scanned image, and performs image processing on the scanned image.

The server 10 associates the scanned image, which is subjected to image processing, with information about the figures drawn by using markers, and stores the result as a document file in the database 20. The process performed by the server 10 on a scanned image will be described below.

### Viewing Examples

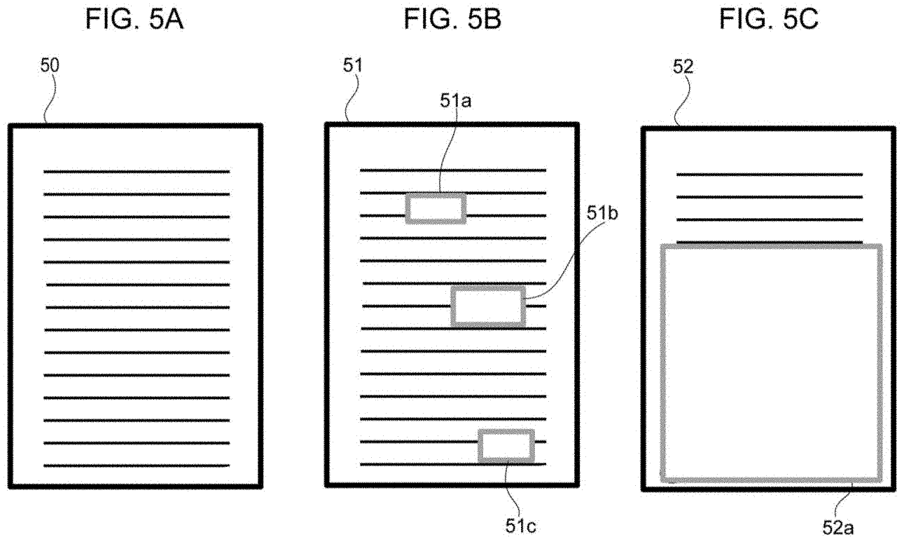

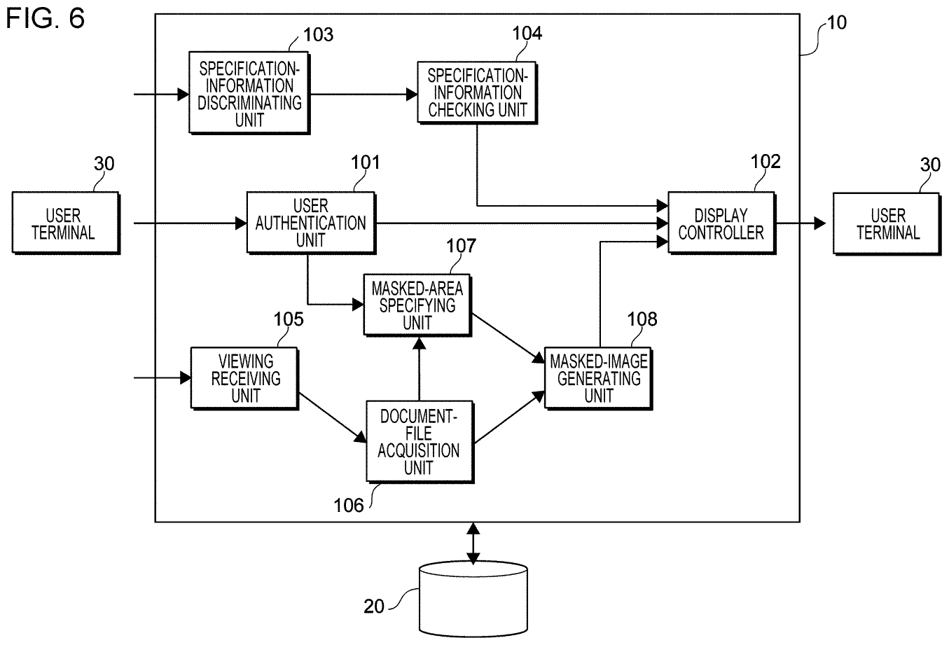

Using FIGS. 4 and 5A to 5C, how the display of a document, in which a manager has specified areas by using marker pens, is made different depending on the category of each viewing user when the user views the document will be described.

FIG. 4 is a diagram illustrating the state in which a manager has specified areas on a paper document 40 by using marker pens. FIGS. 5A to 5C are diagrams illustrating document images displayed depending on the user category of each viewing user when the user views the document in FIG. 4.

FIGS. 41a, 41b, 41c, and 42a in FIG. 4 are substantially rectangular figures drawn by the manager on the paper document 40 by using marker pens. The substantially rectangular figures are drawn by the manager to specify areas restricted on viewing.

The FIGS. 41a, 41b, and 41c are specific figures drawn by the manager by using a marker pen of a predetermined specific color. In this example, as a first specification method, for example, the substantially rectangular figures are drawn by using a blue-ink marker pen. The FIG. 42a is a figure drawn by the manager by using a pen of a color different from that for the FIGS. 41a, 41b, and 41c or by using a different format so that the FIG. 42a has a meaning different from that of the FIGS. 41a, 41b, and 41c. As a second specification method, for example, the substantially rectangular figure is drawn by using a purple-ink marker pen. The manager specifies areas, which are restricted on viewing by a user whose category is “internal user”, by using the first specification method. The manager specifies areas, which are restricted on viewing by a user whose category is “external user”, by using the second specification method different from the first specification method. Thus, the first specification method may be discriminated from the second specification method from the difference between the formats of figures obtained by using the first specification method and the second specification method. In FIG. 4, the first specification method may be discriminated from the second specification method from the difference between the colors of markers which indicate exemplary formats. In this example, marker pens are used to draw figures. Any method may be employed as long as different formats may be recognized. For example, a writing instrument, such as colored pencils or ballpoint pens, may be used.

FIG. 5A illustrates an image displayed when a viewing user whose user category is “manager” views the document in FIG. 4. FIG. 5B illustrates an image displayed when a viewing user whose user category is “internal user” views the document in FIG. 4. FIG. 5C illustrates an image displayed when a viewing user whose user category is “external user” views the document in FIG. 4.

In FIG. 5A, the document 40 is displayed as it is, and the viewing user, who is a manager, may view the document 40 without restriction.

In FIG. 5B, rectangular areas 51a, 51b, and 51c circumscribing the FIGS. 41a, 41b, and 41c, which are figures drawn by using a blue-ink marker pen in FIG. 4, are displayed in white. The viewing user, who is an internal user, is not allowed to view the areas specified by using the first specification method. Specifically, an internal user is not allowed to view the content of the document in the areas specified by the FIGS. 41a, 41b, and 41c drawn on the document 40 by the manager by using a blue-ink marker pen.

In FIG. 5C, a rectangular area 52a circumscribing the FIG. 42a, which is a figure drawn by using a purple-ink marker pen in FIG. 4, is displayed in white. The viewing user, who is an external user, is not allowed to view the area specified by using the second specification method. Specifically, an external user is not allowed to view the content of the document in the area specified by the FIG. 42a drawn on the document 40 by the manager with purple ink.

Thus, in the document management system 1, areas surrounded by using a marker pen of an ink color in accordance with the category of each viewing user are displayed in white, achieving restriction on a viewing area depending on each category for viewing users.

In this example, as a method of restricting viewing of a document, areas restricted on viewing are displayed in white. The method of restricting viewing is not particularly limited to this. For example, viewing may be restricted in any of the following manners: areas restricted on viewing are filled with black; areas restricted on viewing are filled with the color of a marker; restricted parts of the document are replaced with other images.

### The Functional Configuration of the Server 10

The functional configuration of the server 10 according to the present exemplary embodiment will be described.

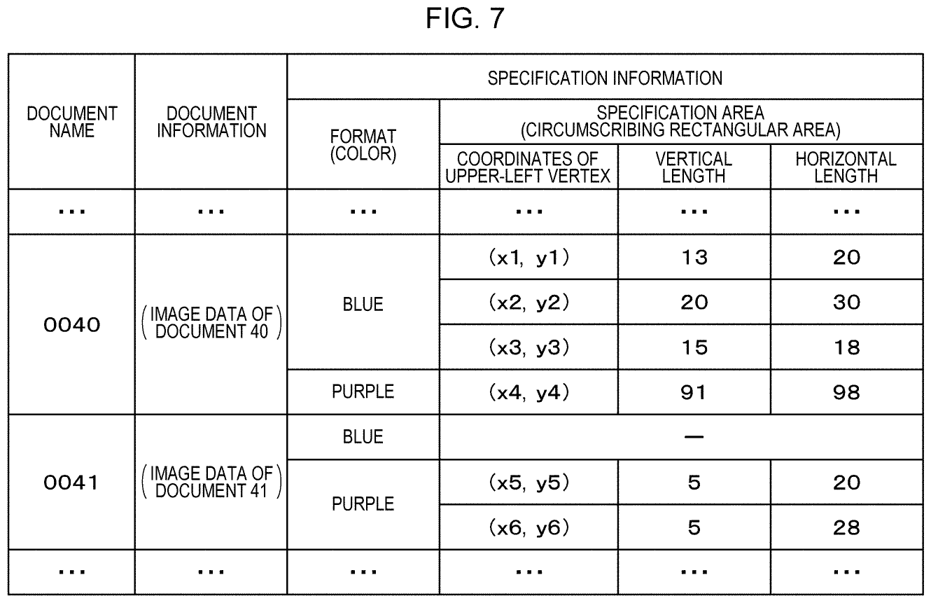

FIG. 6 is a diagram illustrating an exemplary functional configuration of the server 10 according to the present exemplary embodiment.

The server 10 includes a user authentication unit 101 that authenticates a user who uses the document management system 1, a display controller 102 that controls UI images displayed on the display device 36 (see FIG. 3) of the user terminal 30, a specification-information discriminating unit 103 that discriminates information, which has been added by a manager to a document, to specify areas restricted on viewing, a specification-information checking unit 104 that generates an image for a manager checking the discriminated specification information, a viewing receiving unit 105 that receives a request for viewing from a user who wants viewing, a document-file acquisition unit 106 that acquires, from the database 20, a document file for which a request for viewing is received, a masked-area specifying unit 107 that specifies areas, which are to be subjected to masking, in the document for which a request for viewing is received, and a masked-image generating unit 108 that generates a document image in which areas determined by the masked-area specifying unit 107 are filled with white.

The user authentication unit 101 authenticates a user who uses the document management system 1 according to the present exemplary embodiment. The user authentication unit 101 performs an authentication. Thus, the server 10 may recognize the user category of the user.

The display controller 102 generates a UI screen (user interface screen) that is to be displayed on the display device 36 (see FIG. 3) of the user terminal 30, and transmits the UI screen to the user terminal 30.

The document management system 1 uses, for example, a dedicated browser to display the UI screen on the display device 36 of the user terminal 30. Thus, information is presented to the user, and input from the user is received.

The specification-information discriminating unit 103 discriminates figures, which have been added to a document by a manager to specify areas restricted on viewing. The specification-information discriminating unit 103 extracts the formats and areas of the discriminated figures, as specification information. When a document, in which areas are specified on the document by a manager by using marker pens, for example, the scanned image of the document 40 (see FIG. 4), is obtained from the user terminal 30, the specification-information discriminating unit 103 discriminates, from the scanned image, specification information included in the scanned image, that is, the FIGS. 41a, 41b, 41c, and 42a drawn on the document 40 by using markers. The specification-information discriminating unit 103 discriminates specification information and document information which indicates the content of the document, from the colors of markers included in the scanned image. The method of recognizing the colors of markers from a scanned image is, for example, the method described in Japanese Patent No. 3317446. An existing method may be used.

The specification-information discriminating unit 103 specifies areas specified by the discriminated figures. Specifically, the specification-information discriminating unit 103 specifies rectangular areas circumscribing the FIGS. 41a, 41b, 41c, and 42a which are the discriminated substantially rectangular figures. The method of specifying a circumscribing rectangular area is, for example, specification using the xy coordinates whose origin is set to the upper-left corner of the obtained scanned image. A circumscribing rectangular area may be specified by using the xy coordinates of the upper-left vertex of the rectangle and the vertical and horizontal lengths of the rectangle. In the storage device 14 (see FIG. 2), the specification-information discriminating unit 103 temporarily stores, as specification information, the specified rectangular areas in association with each marker color. The method in which the specification-information discriminating unit 103 specifies specification areas is not particularly limited to this. For example, the following methods may be employed: a method in which a rectangular area circumscribing a substantially oblong figure added to the document by a manager is used as a specification area; a method in which a rectangular area, in which a substantially straight line drawn on the document by a manager is set as the diagonal line, is used as a specification area.

The specification-information checking unit 104 checks if the specification information discriminated by the specification-information discriminating unit 103 describes what the manager intends. The specification-information checking unit 104 generates an image for displaying, to the manager, the specification information discriminated by the specification-information discriminating unit 103. The specification-information checking unit 104 displays, to the user, the specification information on the user terminal 30 through the display controller 102, and receives, from the manager, a determination about whether the displayed specification information satisfies the user's intention.

When a determination that the specification information satisfies the manager's intention is received from the manager, the specification-information checking unit 104 stores, in the database 20, the document file stored temporarily in the storage device 14.

The image for a manager checking specification information may be an image in which the figures discriminated as specification information are superimposed on the document image for presentation to the user, or may be images that are to be viewed and that are displayed by the masked-image generating unit 108, which is described below, for the respective user categories for presentation to the manager.

The viewing receiving unit 105 receives, from a viewer, a document name which is information for identifying a document the viewer wants to view. The viewing receiving unit 105 outputs the obtained document name to the document-file acquisition unit 106.

The document-file acquisition unit 106 obtains, from the database 20, the document file for which a request for viewing is received, and outputs, to the masked-image generating unit 108, document information of the document file. The document-file acquisition unit 106 outputs, to the masked-area specifying unit 107, specification information of the document file.

The masked-area specifying unit 107 specifies a format which indicates hidden areas associated with the viewer. The masked-area specifying unit 107 obtains the user category of the viewer authenticated by the user authentication unit 101. The masked-area specifying unit 107 uses a table (described below), in which the user category is associated with the format type, to specify the format in specification information indicating the areas restricted on the viewer's viewing. The masked-area specifying unit 107 determines the specification areas, which are associated with the specified format, as masked areas.

The masked-image generating unit 108 obtains the areas determined by the masked-area specifying unit 107, and generates a document image that is to be viewed by the viewing user. The document image that is to be viewed by the viewing user is an image in which the determined masked areas are filled with white in the image of the document information.

The generated masked image is displayed to the user through the display controller 102.

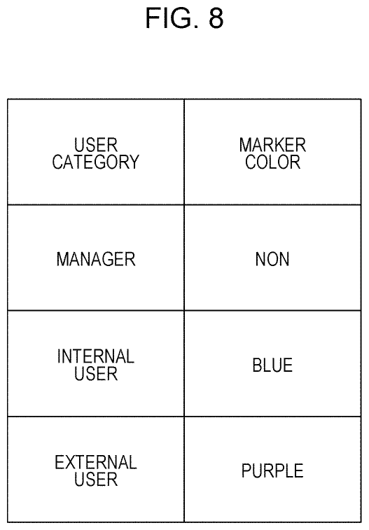

FIG. 7 is a diagram for describing document files stored in the database 20.

Each document file is stored in such a manner that its document name, with which the document file is identified, image data of the document, which serves as document information indicating the content of the document, and specification information for specifying areas restricted on viewing are associated with each other. The specification information includes the format type associated with the user category, and the specification area indicating areas in the document image. For each format type, zero, one, or two or more specification areas are associated. Each specification area is determined on the basis of the corresponding specific figure drawn by a manager by using a marker. For example, a specific area is determined by the coordinates of the upper-left vertex of a rectangle circumscribing a substantially rectangular figure drawn by a manager, and the lengths of the circumscribing rectangle.

The case in which no specification areas are associated with a format indicates, for example, that a document does not need to have restriction on viewing to internal users. In the document, no specification areas are associated with the “blue” format.

In FIG. 7, the document file having a document name of “0040” is associated with “image data of the document 40” as document information, and is further associated with “blue” and “purple” formats. For the “blue” format, three specification areas are associated, and, for the “purple” format, one specification area is associated.

The document file having a document name of “0041” is associated with “image data of the document 41” as document information, and is associated with the “blue” and “purple” formats. For the “blue” format, no specification areas are associated, and, for the “purple” format, two specification areas are associated.

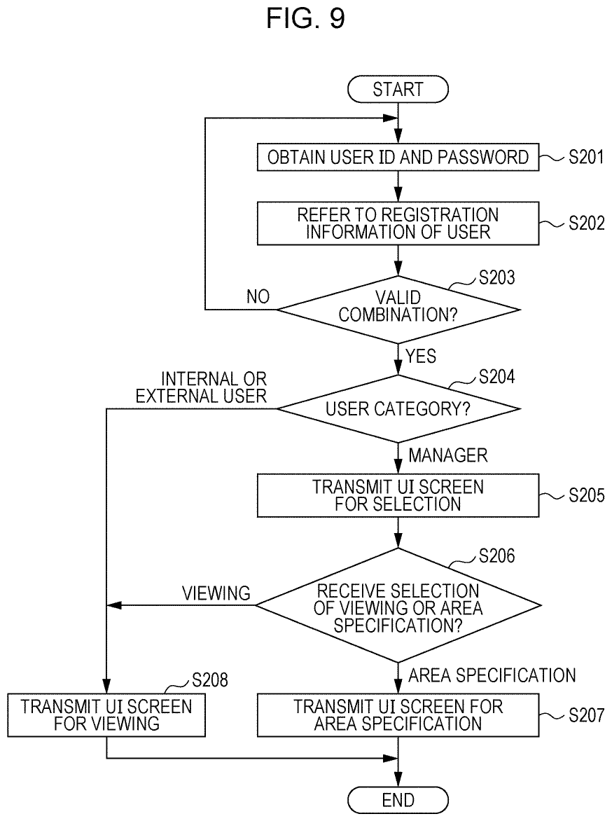

FIG. 8 illustrates an exemplary table in which the user category is associated with the format type.

The table is used to manage the user category and the format type which is associated with the user category. Hereinafter, the table is referred to as a viewing restriction management table.

In the viewing restriction management table in FIG. 8, a user category of “manager” is associated with a marker color of “none”. The marker color, “none”, indicates that a viewing user having a user category of “manager” is allowed to view document information without restriction on viewing. A user category of “internal user” is associated with a marker color of “blue”. This indicates that, when an internal user views documents, areas indicated by specification information having the “blue” format are hidden. A user category of “external user” is associated with a marker color of “purple”. This indicates that, when an “external user” views documents, areas indicated by specification information having the “purple” format are hidden.

### Processes Performed by the Server 10

Processes performed by the server 10 will be described by using flowcharts.

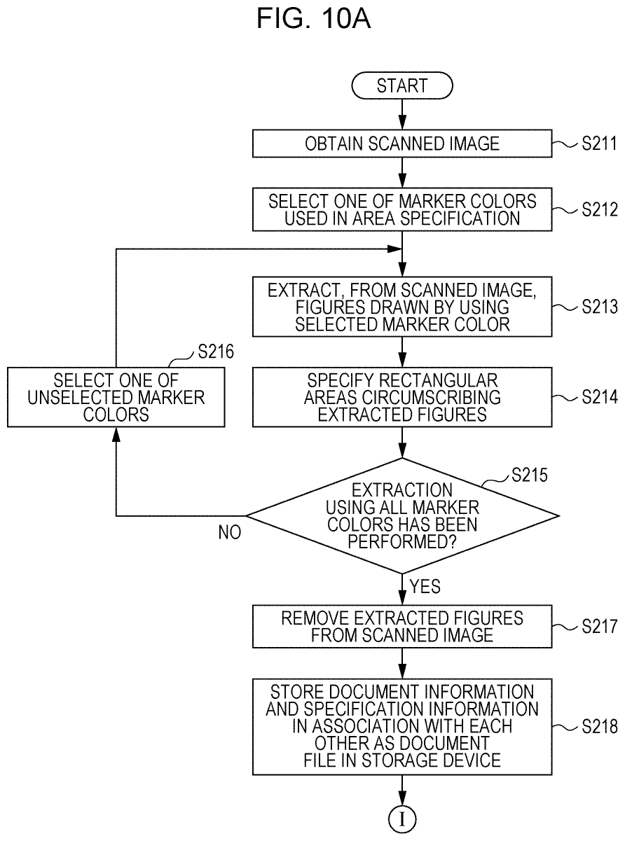

FIG. 9 is a flowchart of a process performed by the server 10 in user authentication.

The user authentication unit 101 obtains a user ID and a password from the user terminal 30 (step 201). The user authentication unit 101 (see FIG. 6) refers to registration information of the user (step 202). The registration information of a user is information which is used in user authentication and in which the user ID, the password, and the user category are associated with each other. The registration information of a user is, for example, recorded in registration of the user.

The user authentication unit 101 determines whether the combination of the user ID and the password, which are obtained in step 201, is valid (step 203). If the combination of the user ID and the password is not valid (NO in step 203), the process returns to step 201, and a user ID and a password are obtained from the user terminal 30. If the user ID and the password have been authenticated as a valid combination in step 203 (YES in step 203), the user category associated with the user ID is determined (step 204).

If the user category indicates an internal user or an external user in step 204, the display controller 102 transmits, to the user terminal 30, a UI screen for viewing (step 208), and the process ends. The UI screen for viewing has a function of receiving the user's desire for viewing and the name of a document the user wants to view.

If it is determined that the user category indicates a manager in step 204, the display controller 102 transmits a UI screen for selection (step 205). The UI screen for selection has a function of making selection of whether a document is to be viewed or area specification of a document is to be performed.

Upon reception of the manager's selection of viewing or area specification in step 206, if selection of “viewing” is received, the UI screen for viewing is transmitted (step 208), and the process ends. If selection of “area specification” is received in step 206, a UI screen for area specification is transmitted (step 207), and the process ends.

The UI screen for area specification is a UI image for specifying specification areas on a document, and has, for example, a function of receiving a scanned image of the document in which areas are specified on a paper medium by using markers.

A process, which is performed by the server 10 when a manager specifies areas on a paper document by using multiple ink colors, will be described.

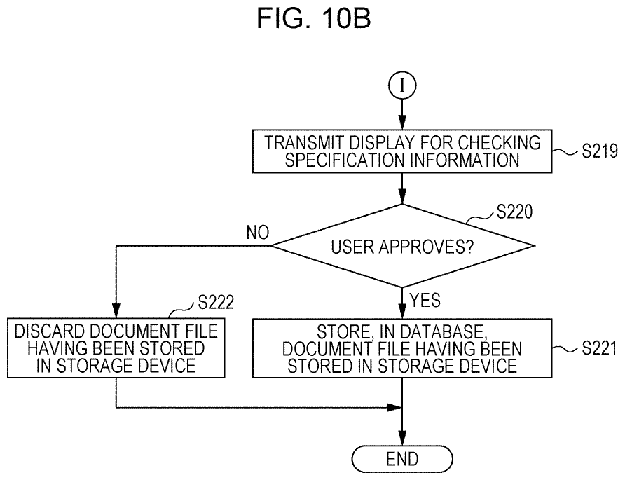

FIGS. 10A and 10B are flowcharts of a process performed by the server 10 in registration of a document.

The specification-information discriminating unit 103 (see FIG. 6) obtains a scanned image of a document, in which a manager has specified areas on a paper document by using markers, from the user terminal 30 operated by the manager (step 211). The specification-information discriminating unit 103 selects one of the marker colors indicating the format types in the viewing restriction management table (see FIG. 8), that is, the marker colors used in area specification (step 212), and extracts, from the scanned image, figures drawn by using the selected color (step 213). The specification-information discriminating unit 103 further specifies rectangular areas circumscribing the extracted figures (step 214). The specification-information discriminating unit 103 determines whether extraction using all the marker colors described in the viewing restriction management table has been performed (step 215). If extraction using all the marker colors has not been performed (NO in step 215), the specification-information discriminating unit 103 selects one of the unselected marker colors (step 216). Then, the process returns to step 213, and figures drawn by using the selected marker color are extracted from the scanned image (step 213).

If the specification-information discriminating unit 103 determines that extraction using all the marker colors has been performed in step 215 (YES in step 215), the specification-information discriminating unit 103 performs image processing of removing the extracted figures from the scanned image (step 217). The image, which is obtained by removing the extracted figures from the scanned image, is used as document information, and the marker colors of the extracted figures and the circumscribing rectangular areas are used as specification information. The document information and the specification information are stored in the storage device 14 (see FIG. 2) as a document file in association with each other (step 218).

The specification-information checking unit 104 generates a display for checking the specification information, and the display controller 102 transmits, to the user terminal 30, the generated display for checking (step 219). The display for checking is used to check if the figures specified by the manager are recognized in the image recognition, which is performed by the server 10, as intended by the manager. The specification-information checking unit 104 receives selection about whether the specification information of the document file, which is stored in the storage device 14, satisfies the user's intention (step 220). If the user approves (YES in step 220), the document file, which has been stored in the storage device 14, is stored in the database 20 (step 221), and the process ends. If the user does not approve in step 220 (NO in step 220), the document file, which has been stored in the storage device 14, is discarded (step 222), and the process ends.

A process performed by the server 10 when a request to view a document is received from a viewing user will be described.

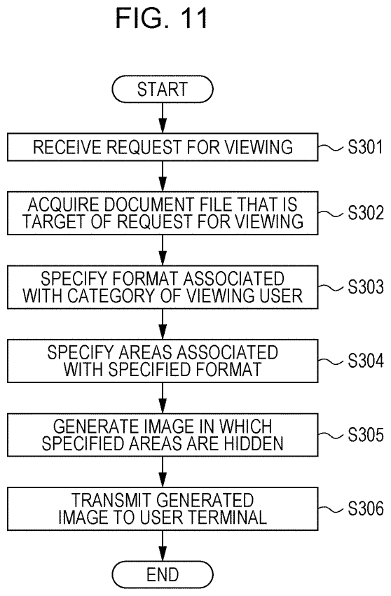

FIG. 11 is a flowchart of a process performed by the server 10 in display of a document to a user.

The viewing receiving unit 105 (see FIG. 6) receives, from a viewing user, a request for viewing (step 301). The document-file acquisition unit 106 acquires, from the database 20, a document file that is a target of the request for viewing (step 302). The masked-area specifying unit 107 refers to the viewing restriction management table to specify the format associated with the category of the viewing user (step 303), and specifies specification areas associated with the specified format (step 304). The masked-image generating unit 108 generates a document image in which the specified areas are hidden (step 305). The display controller 102 transmits, to the user terminal 30, the document image generated by the masked-image generating unit 108 (step 306), and the process ends.

### Modified Examples

When areas restricted on viewing are to be specified on a document which is already in electronic form, instead of the method of specifying areas directly by using markers on a paper document, a manager may specify areas on a document, which is displayed on a display, by adding figures by using an electronic method. For example, a document which is already in electronic form is a document image generated by scanning a paper document before a manager specifies areas by using markers, or a document generated, for example, by using software of generating a document. Examples of the electronic method include a method of drawing a figure on a document, which is displayed on a display, by using an electronic pen, and a method of drawing a figure through mouse operation.

A method of specifying areas may be discriminated through difference between the colors of figures added electronically. A method of specifying areas may be discriminated through the format of the lines included in a figure added electronically. The format of a line is a format selectable by a manager in electronic addition of a figure, and is, for example, the type of a line, such as solid line, broken line, dotted line, or wavy line, or the width of a line.

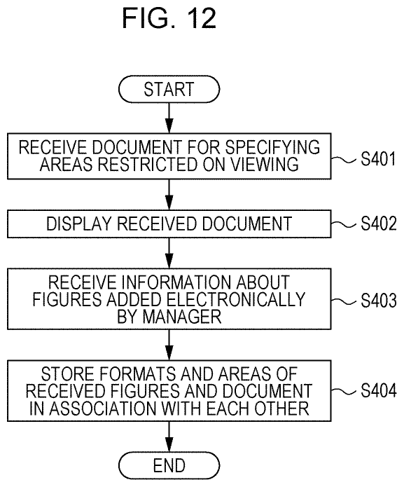

FIG. 12 is a flowchart of a process performed by the server 10 in reception of area specification using an electronic pen.

The server 10 receives, from a manager, a document for specifying areas restricted on viewing (step 401). The server 10 displays the received document on the user terminal 30 (step 402). When the manager adds figures on the document, which is displayed on the user terminal 30, by using an electronic method, the server 10 receives information about the figures added electronically by the manager (step 403). The server 10 stores, in the database 20, the formats and the areas of the received figures, and the document in association with each other (step 404), and the process ends.

In the exemplary embodiments of the present disclosure, it is not necessary to prepare different document images for the respective user categories for storage in the database 20. When a request for viewing is given, a document image according to the user category may be generated from a single document image.

In the exemplary embodiments of the present disclosure, the server 10 obtains a scanned image of a document in which a manager has specified areas on a paper document by using markers, and the document image, which indicates the content of the document, and the specification information for specifying areas are extracted from the scanned image. The server 10 stores, in the database 20, the document image and the specification information in association with each other. However, for example, when a manager does not need to check the specification information, the server 10 may store the obtained scanned image, as it is, in the database 20. When a request for viewing is given, the server 10 may extract the document image and the specification information from the scanned image. In this way, the specification information is not stored, achieving a reduction of the amount of storage of document files stored in the database 20.

Part of information processing performed by the server 10 of the document management system 1 may be performed by the user terminal 30.

In the embodiments above, the term “processor” refers to hardware in a broad sense. Examples of the processor include general processors (e.g., CPU) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
receive a request to view a document, from a viewing user who views the document;
obtain a document file having document information and specification information, the document information describing content of the document, the specification information including a plurality of figures disposed on the document, the plurality of figures having a plurality of format types, the plurality of figures being used to specify areas in the document;
obtain user information describing the viewing user; and,
in display of the document to the viewing user, determine hidden areas on a basis of a format type associated with the user information in advance, the hidden areas being in the document and being areas in which the content of the document is not displayed.

2. The information processing apparatus according to claim 1,
wherein the plurality of figures are figures formed on the document drawn on a medium.

3. The information processing apparatus according to claim 2,
wherein the hidden areas are rectangular areas in the document, the rectangular areas being specified by the plurality of figures.

4. The information processing apparatus according to claim 2,
wherein the plurality of format types indicate colors of the formed figures.

5. The information processing apparatus according to claim 1,
wherein the plurality of figures are figures added electronically on the document on a screen.

6. The information processing apparatus according to claim 5,
wherein the plurality of format types indicate formats of lines included in the plurality of figures, the formats of lines being selected when the hidden areas are set.

7. The information processing apparatus according to claim 1,
wherein the hidden areas are displayed in an identical display format, not using the format associated with the user information in advance.

8. A non-transitory computer readable medium storing a program causing a computer to execute a process comprising:
receiving a request to view a document, from a viewing user who views the document;
obtaining a document file having document information and specification information, the document information describing content of the document, the specification information including a plurality of figures disposed on the document, the plurality of figures having a plurality of format types, the plurality of figures being used to specify areas in the document;
obtaining user information describing the viewing user; and,
in display of the document to the viewing user, determining hidden areas on a basis of a format type associated with the user information in advance, the hidden areas being in the document and being areas in which the content of the document is not displayed.

9. An information processing method comprising:
receiving a request to view a document, from a viewing user who views the document;
obtaining a document file having document information and specification information, the document information describing content of the document, the specification information including a plurality of figures disposed on the document, the plurality of figures having a plurality of format types, the plurality of figures being used to specify areas in the document;
obtaining user information describing the viewing user; and,
in display of the document to the viewing user, determining hidden areas on a basis of a format type associated with the user information in advance, the hidden areas being in the document and being areas in which the content of the document is not displayed.
